(19) United States
(12) Patent Application Publication
(10) Pub. No.: US 2006/0023308 A1
(43) Pub. Date: Feb. 2, 2006

(54) Infrared polarization rotation element

(76) Inventor: Jeffrey H. Hunt, Thousand Oaks, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 10/903,799

(22) Filed: Jul. 29, 2004

(51) Int. Cl. G02B 6/26

(52) U.S. Cl. 359/500; 359/496

(57) ABSTRACT

A polarization rotation element is provided. In one embodiment, the polarization rotation element includes a first polarizing member having a first surface and a second surface, the first surface configured to internally reflect input light to the second surface, the second surface configured to internally reflect light from the first surface and transmit the reflected light, and a second polarizing member element having a first surface and a second surface, the first surface configured to internally reflect the transmitted light from the first polarizing member to the second surface, the second surface configured to internally reflect light from the first surface and transmit the reflected light.

### BACKGROUND

Light may be described as an electromagnetic wave that propagates via a sinusoidal oscillation of two fields: an electric field and a magnetic field. More specifically, the electromagnetic wave phenomenon comprises an electric field vector and a magnetic field vector. Generally, these field vectors oscillate at right angles to each other and to the direction of propagation. FIG. 1 shows representation of an electromagnetic wave 1 propagating through a medium and comprising an electric field vector 3 and a magnetic field vector 5. The direction in which the electric field vector 3oscillates as the electromagnetic wave propagates is known as the polarization.

Numerous applications require the rotation of the polarization of an electromagnetic wave. Presently, there are a number of polarization rotation devices available. One class of these devices achieves the rotation of the polarization by creating a phase retardation between the electric field vector 3 and the magnetic field vector 5 of the electromagnetic wave 1 based on the birefringence of material forming the polarizer. While these devices have proven useful for some applications, a number of shortcomings have been identified. For example, these retardation plates are commonly used to effect polarization rotation of light in the visible spectrum. As such, in other areas of the electromagnetic spectrum, such as the infrared portion, retardation plates are of limited value since the known birefringent materials forming these retardation plates are not easily obtainable.

In light of the foregoing, there is an ongoing need for a polarization rotation element configured for use at a variety of wavelengths.

### BRIEF SUMMARY

Various embodiments of polarization rotation elements are disclosed herein. In one embodiment, a polarization rotation element is disclosed and includes a first polarizing member having a first surface and a second surface, the first surface configured to internally reflect input light to the second surface, the second surface configured to internally reflected light from the first surface and transmit the reflected light, and a second polarizing member element having a first surface and a second surface, the first surface configured to internally reflect the transmitted light from the first polarizing member to the second surface, the second surface configured to internally reflected light from the first surface and transmit the reflected light.

In an alternate embodiment, a polarization rotation element is disclosed and includes a first polarizing member having a first surface and a second surface, the first surface oriented at an angle greater than a minimum angle of total internal reflectance relative to an optical axis perpendicular of the first surface, the second surface oriented at an angle greater than a minimum angle of total internal reflectance relative to the optical axis perpendicular of the second surface, a second polarizing member element having a first surface and a second surface, the first surface oriented at an angle greater than a minimum angle of total internal reflectance relative to the optical axis perpendicular of the first surface, the second surface oriented at an angle greater than a minimum angle of total internal reflectance relative to the optical axis perpendicular of the second surface.

In addition, the present application discloses numerous methods of rotating the polarization of incident light. In one embodiment, a method of rotating the polarization of light is disclosed and includes irradiating a first polarizing member with incident light having a first polarization, reflecting the incident light from a first surface of the first polarizing member to a second surface of the first polarizing member using total internal reflectance, reflecting from the second surface of the first polarizing member the light from the first surface using total internal reflectance, reflecting the incident light from a first surface of the second polarizing member to a second surface of the second polarizing member using total internal reflectance, reflecting from the second surface of the second polarizing member the light from the first surface using total internal reflectance, and transmitting light having a second polarization from the second polarizing member.

In another embodiment, a method of rotating the polarization of light is disclosed and includes irradiating a polarization rotation element comprised of a first polarizing member and a second polarizing member with the incident light having a first polarization, reflecting the incident light from at least four surfaces of the polarization rotation element, wherein the surfaces are configured to reflect the incident light using total internal reflectance, and transmitting light having a second polarization from the polarization rotation element.

Other features and advantages of the embodiments of polarization rotation elements as disclosed herein will become apparent from a consideration of the following detailed description.

### BRIEF DESCRIPTION OF THE DRAWINGS

Various polarization rotation elements will be explained in more detail by way of the accompanying drawings, wherein:

FIG. 1 shows an illustration of an electromagnetic wave propagating through space;

FIG. 2A shows a side view of an embodiment of a polarization rotation element having a first polarizing member and a second polarizing member;

FIG. 2B shows a side view of an alternate embodiment of a polarization rotation element having a first polarizing member coupled to a second polarizing member;

FIG. 3 shows a side view of an embodiment of a first polarizing member for use in forming a polarization rotation element;

FIG. 4 shows a side view of an embodiment of a second polarizing member for use in forming a polarization rotation element;

FIG. 5 shows a perspective view of an embodiment of a polarization rotation element;

FIG. 6 shows a side view of an embodiment of a polarization rotation element being irradiated with incident light;

FIG. 7 shows a side view of incident light reflected of surfaces of an embodiment of a first polarizing member;

FIG. 8 shows a side view of incident light reflected of surfaces of an embodiment of a second polarizing member;

FIG. 9 shows a perspective view of an alternate embodiment of a polarization rotation element configured to move along an arc to adjustably rotate the polarization of incident light; and

FIG. 10 shows a perspective view of the embodiment of a polarization rotation element shown in FIG. 9 adjustably rotating the polarization of incident light.

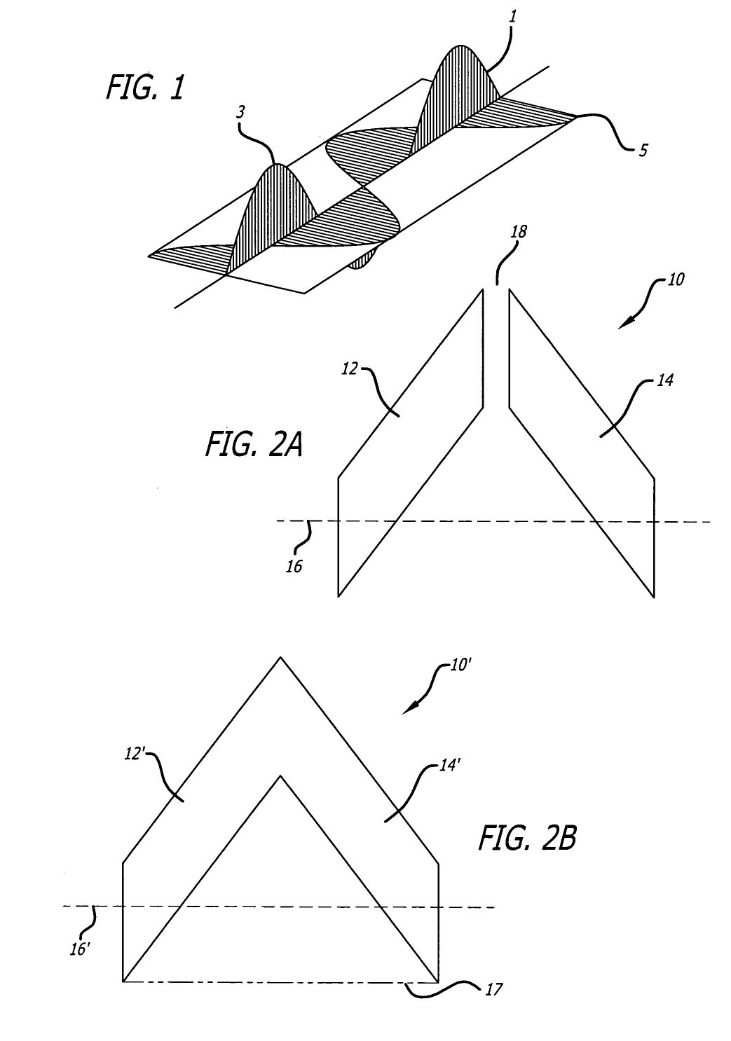

### DETAILED DESCRIPTION

FIG. 2A shows an embodiment of a polarization rotation element. As shown, the polarization rotation element 10 may include a first polarizing member 12 and a second polarizing rotation member 14 positioned on an optical axis 16. In one embodiment, the first and second polarizing members 12, 14 are separated by gap 18. In an alternate embodiment, the first and second polarizing members 12, 14 may be in contact, thereby eliminating the gap 18 positioned therebetween. In the illustrated embodiment, the polarization rotation element 10 is formed from separate first and second polarizing members 12, 14. In one embodiment, the first and second polarizing members 12, 14 are manufactured from the same material. Optionally, the first and second polarizing members 12, 14 may be manufactured from different materials. Exemplary materials include, without limitation, silicon, sapphire, zinc sulfide, zinc sulfide multispectral, zinc selenide, and germanium.

In an alternate embodiment, the polarization rotation element 10 may be formed from a unitary body defining the first and second polarizing members 12, 14. FIG. 2B shows an embodiment of a polarization rotation element 10′ having a unitary body formed from a first polarizing member 12′ and a second polarizing member 14′ positioned on an optical axis 16′. Optionally, the polarization rotation element 10′ may include a body portion 17 positioned between the first and second polarizing members 12′, 14′. The body portion 17 may be manufactured from any variety of materials. For example, in one embodiment, the body portion 17 is manufactured from the same material as the first and second polarization rotation members 12′, 14′. In an alternate embodiment, the body portion 17 is manufactured from a different material than the first and second polarizing members 12′, 14′.

The polarization rotation element 10 may be manufactured from any variety of materials. For example, in one embodiment, the polarization rotation elements 10 is manufactured from silica glass. Optionally, the polarization rotation element 10 may be manufactured from a material optically transparent at a defined wavelength. For example, the polarization rotation element 10 may be manufactured from a material optically transparent to electromagnetic radiation having a wavelength greater than about 1 micron to about 2 microns.

FIG. 3 shows an embodiment of a first polarizing member 12. As shown, the first polarizing member 12 includes a body member 22 defined by a first surface 24 and a second surface 26. A radiation receiving surface 28 is in communication with the first and second surfaces 24, 26 of the body member 22. Similarly, a radiation transmitting surface 30 is positioned distally from the radiation receiving surface 28 and is in communication with the first and second surfaces 24, 26 of the body member 22.

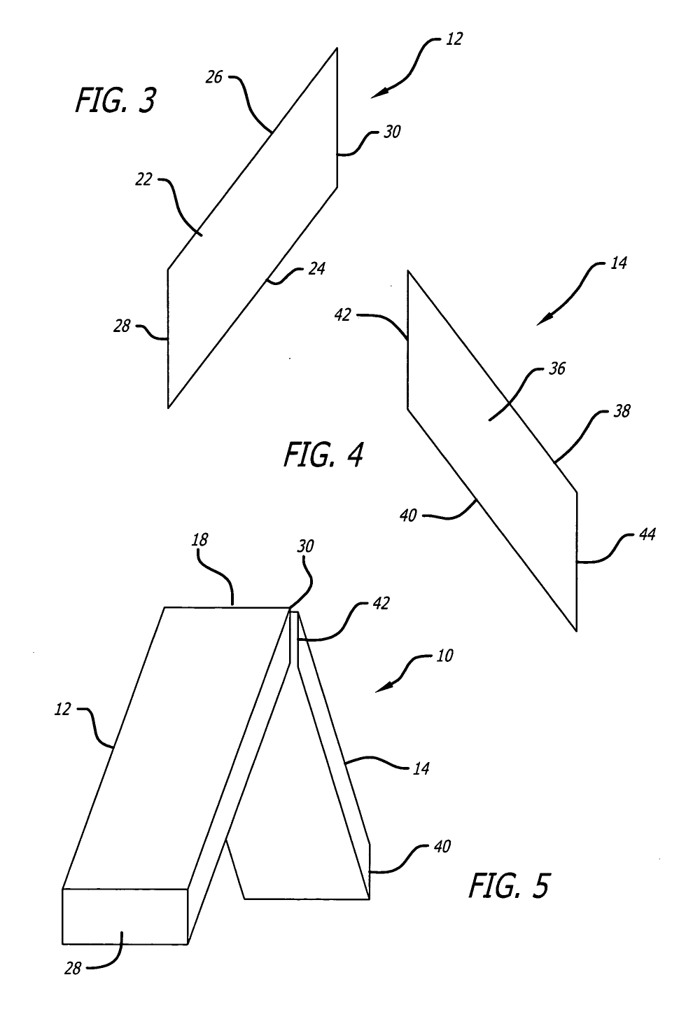

FIG. 4 shows an embodiment of a second polarizing member 14. As shown, the second polarizing member 14 includes a body member 36 defined by a first surface 38 and a second surface 40. A radiation receiving surface 42 is in communication with the first and second surfaces 38, 40 of the body member 36. Similarly, a radiation transmitting surface 44 is positioned distally from the radiation receiving surface 42 and is in communication with the first and second surfaces 38, 40 of the body member 36. As shown in FIGS. 3 and 4, in one embodiment the first and second polarizing members 12, 14 individually form a rhombus-like structure. Optionally, the first and second polarizing members 12, 14 may be formed in any number of shapes as desired by the user. In the illustrated embodiments, the first and second surfaces 24, 26, 38, 40 of the first and second polarizing members 12, 14 are parallel. Optionally, first surfaces 24, 40 may not be parallel to the second surfaces 26, 40 of the first and second polarizing members 12, 14.

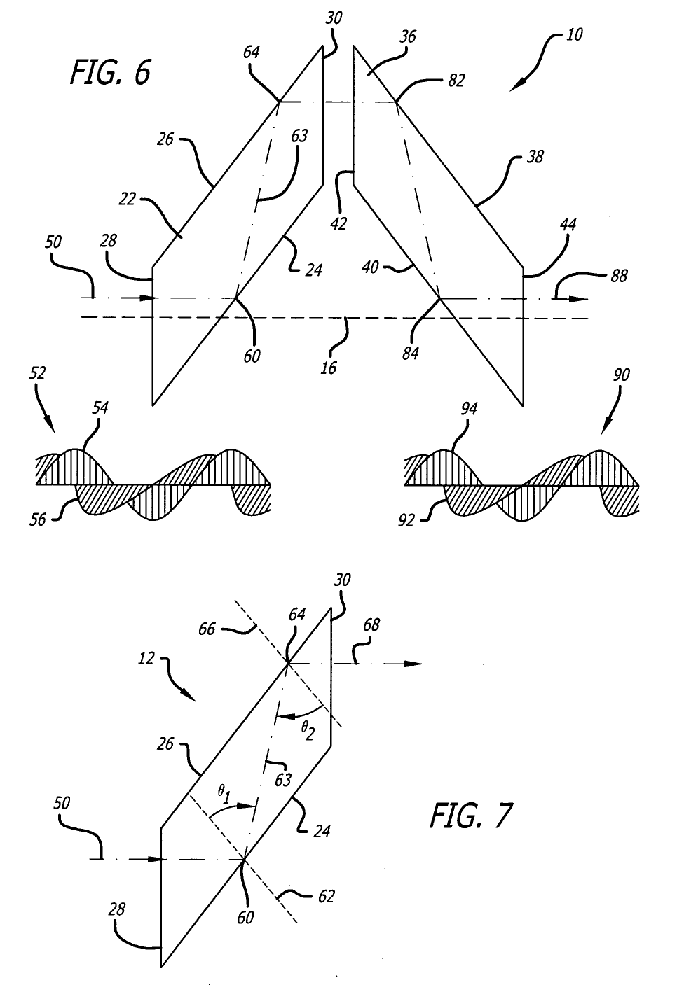

FIGS. 5-8 show an embodiment of the polarization rotation element 10 during use. As shown in FIG. 5, the radiation transmitting surface 30 of the first polarizing member 12 is positioned proximate to the radiation receiving surface 42 of the second polarizing member 14. As described above, in one embodiment the first and second polarizing members 12, 14 are separated by a gap 18. Optionally, the first and second polarizing members 12, 14 may be in communication. As shown in FIGS. 6 and 7, an input of electromagnetic radiation or light 50 is incident on the receiving surface 28 of the first polarizing member 12. The input light 50 has a first polarization 52 wherein the electric field vector 54 has a vertical orientation and the magnetic field vector 56 has a horizontal orientation.

Referring to FIGS. 6 and 7, the input light 50 is transmitted through the receiving surface 28 of the first polarizing member 12 and is incident on the first surface 24 of the body 22. The input light 50 is incident on the first surface 24 at an angle θ₁, measured from the perpendicular optical axis 62, which is greater than the minimum angle of total internal reflectance. As such, light 63 is internally reflected by the first surface 24 at a first reflection site 62. Thereafter, the internally reflected light 63 is incident on the second surface 26 at an angle θ₂, measured from the perpendicular optical axis 66, which is again greater than the minimum angle of total internal reflectance. As shown in FIG. 7, the light 68 is transmitted through the transmitting surface 30 of the first polarizing member 12.

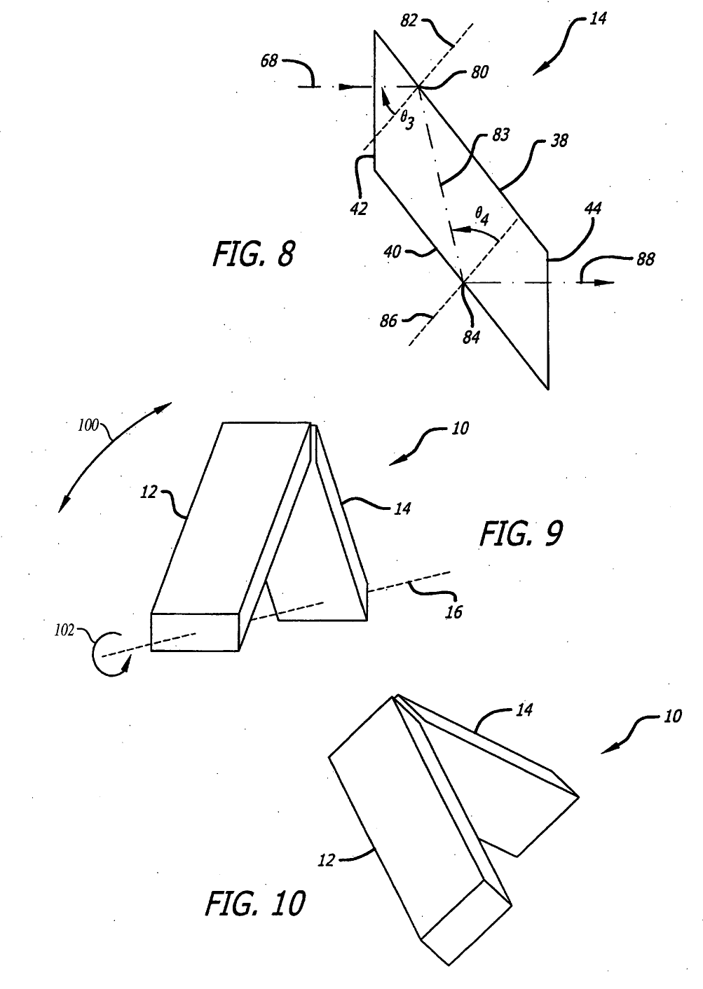

As shown in FIGS. 6 and 8, the light 68 through the transmitting surface 30 of the first polarizing member 12 is transmitted through the receiving surface 42 and is incident on the first surface 38 of the body 36 of the second polarizing member 14. The received light 68 is incident on the first surface 38 at an angle θ₃, measured from the perpendicular optical axis 82, which is greater than the minimum angle of total internal reflectance. As such, light 83 is internally reflected by the first surface 38 at a third reflection site 80. Thereafter, the internally reflected light 83 is incident on the second surface 40 at an angle θ₄, measured from the perpendicular optical axis 86, which is again greater than the minimum angle of total internal reflectance. As shown in FIG. 8, the output light 88 is transmitted through the transmitting surface 44 of the second polarizing member 14. Referring again to FIG. 6, the output light 88 has a second polarization 90 wherein the electric field vector 92 has a horizontal orientation and the magnetic field vector 94 has a vertical orientation. Therefore, the polarization of the field vectors 92, 94 of the output light 88 has been rotated approximately 90 degrees as compared with the orientation of the field vectors 52, 54 of the input light 50 by the polarization rotation element 10.

As stated above, the polarization rotation element 10 shown in FIGS. 2-8 may be manufactured from any variety of materials. For example, in one embodiment the first and second polarizing members 12, 14 are manufactured from the same material. In an alternate embodiment, the first and second polarizing members 12, 14 are manufactured from different material. Similarly, the first and second polarizing members 12, 14 may be positioned on equal or differing angles. Further, a mathematical equation may be used to produce the desired phase retardation. For example, in one embodiment, a phase retardation may be calculated using the following equation:

$$\sqrt{2} = \frac{cos {θ}_{S} \sqrt{{sin}^{2} {θ}_{S} - ( 1 / {η}^{2} )}}{{sin}^{2} {θ}_{S}}$$

where n represents the index of refraction of the material forming the polarization rotation device. As such, in one embodiment, the polarization rotation element 10 utilizes the total internal reflection of light from the first and second surface 22, 24 of the first polarizing member 12 and the first and second surface 36, 40 of the second polarizing member 14 in achieving phase retardation.

Optionally, the polarization of light incident upon the polarization rotation element 10 may be further altered by moving the first and second polarizing member 12, 14 when irradiated with light. FIGS. 9 and 10 illustrate an embodiment of a polarization rotation element 10 having an optical axis 16. During use, the polarization rotation element 10 may be mounted within an optical mount (not shown) and rotated along arc 100 about the optical axis 16. Therefore, input light (not shown) co-axially positioned along the optical axis 16 incident upon the polarization rotation element 10 will undergo polarization rotation relative to the rotation of the polarization rotation element 10 about the arc 100. In one embodiment, the polarization rotation element 10 is rotated to a desired angular displacement 102 and irradiated with input light to produce a desired or predetermined polarization rotation. Optionally, the polarization rotation element 10 may be continuously moving along arc 100 or stationary at a desired angular displacement when irradiated with light.

Embodiments disclosed herein are illustrative of the principles of the invention. Other modifications may be employed which are within the scope of the invention. Accordingly, the devices disclosed in the present application are not limited to that precisely as shown and described herein.

1. A polarization device, comprising:
a first polarizing member having a first surface and a second surface, the first surface configured to receive light input to the device and internally reflect the input light to the second surface, the second surface configured to internally reflect light from the first surface and transmit the reflected light; and
a second polarizing member having a first surface and a second surface, the first surface of the second polarizing member configured to internally reflect the transmitted light from the first polarizing member to the second surface of the second polarizing member, the second surface of the second polarizing member configured to internally reflect light from the first surface of the second polarizing member and transmit the reflected light from the device, wherein the device is formed from a unitary body defining the first and second polarizing members.

2. The device of claim 1 wherein the first surface of the first polarizing member is configured to totally internally reflect the input light.

3. The device of claim 1 wherein the second surface of the first polarizing member is configured to totally internally reflect light from the first surface of the first polarizing member.

4. The device of claim 1 wherein the first surface of the second polarizing member is configured to totally internally reflect input light.

5. The device of claim 1 wherein the second surface of the second polarizing member is configured to totally internally reflect light from the first surface of the second polarizing member.

6. The device of claim 1 wherein the first and second polarizing members are manufactured from the same material.

7. The device of claim 1 wherein the first and second polarizing members are manufactured from different materials.

8. The device of claim 1 wherein the at least one of the first and second polarizing members are manufactured from a material selected from the group consisting of silicon, sapphire, zinc sulfide, zinc sulfide multi-spectral, zinc selenide, and germanium.

9. (canceled)

10. The device of claim 1 wherein the first and second polarizing members are configured to be rotated about an optical axis.

11. A polarization device, comprising:
a first polarizing member having a first surface and a second surface, the first surface oriented at an angle greater than a minimum angle of total internal reflectance relative to an optical axis perpendicular of the first surface, the second surface oriented at an angle greater than a minimum angle of total internal reflectance relative to the optical axis perpendicular of the second surface; and
a second polarizing member having a first surface and a second surface, the first surface of the second polarizing member oriented at an angle greater than a minimum angle of total internal reflectance relative to the optical axis perpendicular of the first surface of the second polarizing member, the second surface of the second polarizing member oriented at an angle greater than a minimum angle of total internal reflectance relative to the optical axis perpendicular of the second surface of the second polarizing member, wherein the device is formed from a unitary body defining the first and second polarizing members.

12. The device of claim 11 wherein at least one of the first and second polarizing members are manufactured from a material selected from the group consisting of silicon, sapphire, zinc sulfide, zinc sulfide multispectral, zinc selenide, and germanium.

13. (canceled)

14. The device of claim 11 further comprising a body portion positioned between the first and second polarizing members.

15. The device of claim 11 wherein the first and second polarizing members are configured to be rotated about an optical axis.

16. The device of claim 11 wherein at least one of the first and second polarizing members forms a rhombus.

17. The device of claim 11 wherein the first polarizing member includes at least one of a receiving surface and a transmitting surface positioned between the first and second surfaces.

18. The device of claim 11 wherein the second polarizing member includes at least one of a receiving surface and a transmitting surface positioned between the first and second surfaces.

19. A method of rotating the polarization of an incident light, comprising:
irradiating a first polarizing member with incident light having a first polarization;
reflecting the incident light from a first surface of the first polarizing member to a second surface of the first polarizing member using total internal reflectance;
reflecting from the second surface of the first polarizing member the light from the first surface using total internal reflectance;
reflecting the incident light from a first surface of the second polarizing member to a second surface of a second polarizing member using total internal reflectance;
reflecting from the second surface of the second polarizing member the light from the first surface of the second polarizing member using total internal reflectance; and
transmitting light having a second polarization from the second polarizing member, wherein the reflecting and transmitting operations are performed by a device formed from a unitary body defining the first and second polarizing members.

20. The method of claim 19 wherein the polarization of the light transmitted from the second polarizing member is rotated 90 degrees from the irradiating light incident upon the first polarizing member.

21. The method of claim 19 further comprising rotating the first and second polarizing members about an optical axis while being irradiated with incident light.

22. A method of rotating the polarization of light, comprising:
irradiating a polarization rotation element comprised of a first polarizing member and a second polarizing member with the incident light having a first polarization;
reflecting the incident light from at least four surfaces of the polarization rotation element, wherein the surfaces are configured to reflect the incident light using total internal reflectance; and
transmitting light having a second polarization from the polarization rotation element, wherein the polarization rotation element is formed from a unitary body defining the first and second polarizing members.
